(19) United States
(12) Patent Application Publication
(10) Pub. No.: US 2025/0314473 A1
(43) Pub. Date: Oct. 9, 2025

(54) DIGITAL CALIPER AND METHOD OF MEASURING INNER DIAMETER OF HOLE USING THE SAME

(71) Applicant: Guilin Gemred Sensor Technology Co., Ltd., Guilin (CN)

(72) Inventors: Bingheng LI, Guilin (CN); Guangjin LI, Guilin (CN); Guanglu YANG, Guilin (CN); Xiamei WEN, Guilin (CN); Mengying SHI, Guilin (CN)

(21) Appl. No.: 19/023,123

(22) Filed: Jan. 15, 2025

(30) Foreign Application Priority Data
Apr. 8, 2024 (CN) 202410416908.4

(51) Int. Cl. G01B 3/20

(52) U.S. Cl. CPC G01B 3/205

(57) ABSTRACT

A digital caliper, including a measurement assembly; and an electronic module. The measurement assembly includes a caliper frame and a caliper body; the caliper frame is slidable on the caliper body. The electronic module includes a displacement sensor and a function module; the displacement sensor includes a fixed grating plate and a movable grating plate; the displacement sensor further includes a sensor chip disposed on the movable grating plate; the fixed grating plate is fixedly disposed on the caliper body; the movable grating plate is electrically connected to the function module; the movable grating plate is fixedly disposed on the caliper frame, and is movable together with the caliper frame; the function module includes a microcontroller, a measurement trigger mechanism, and a set button; the measurement trigger mechanism is configured to generate an on/off electrical signal when the caliper frame is moved.

### CROSS-REFERENCE TO RELATED APPLICATIONS

Pursuant to 35 U.S.C. § 119 and the Paris Convention Treaty, this application claims foreign priority to Chinese Patent Application No. 202410416908.4 filed Apr. 8, 2024, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of measuring tools, and particularly, to a digital caliper and a method of measuring an inner diameter of a hole using the same.

Conventional digital calipers have their measurement functions and characteristics integrated within a specialized integrated circuit (IC). The conventional digital calipers typically convert the measurement data into physical quantities, such as millimeters or inches. The conversion is done with a fixed resolution. The physical quantities are the displayed on the digital screen for the user to read. However, the conventional digital calipers cannot be modified or expanded to add new features or adapt to specific needs.

A typical caliper has both inner jaws used to measure internal dimensions and outer jaws used for external measurement. For calibration of a zero-point error, the conventional caliper usually uses the measuring surfaces of the outer jaws to close naturally and establish a baseline reference for measurement. Manufacturing and installation errors between the measuring surfaces of the inner jaws and outer jaws cause zero-point errors in the inner jaws. The manufacturing and installation errors make the measurements taken by the inner jaws less accurate than those taken by the outer jaws, reducing the precision of internal measurements. Calipers with a pair of knife-edge measuring surfaces may suffer from a displacement error when measuring small inner diameters of a circular ring or hole. The displacement error depends on several factors, such as the thickness of the pair of knife-edge measuring surfaces and the gap between the inner jaws. For instance, the pair of knife-edge measuring surfaces has a total thickness of 0.3 mm a knife-edge measuring surface has and the gap between the inner jaws has a thickness of 0.1 mm. When measuring small inner diameters, such as a 5 mm hole, the configuration introduces an inherent displacement error of about 0.04 mm. The displacement error increases as the inner diameter decreases, meaning smaller holes are subject to larger measurement errors.

The inherent error when measuring small holes with the conventional calipers is significant. The inherent error arises from the issues like the zero-point error and the displacement error. Due to the errors, the conventional calipers are unsuitable for accurately measuring small-diameter holes. Because of the accuracy limitations of the conventional calipers, the high-precision measurements of small-diameter holes require specialized measuring tools. However, the specialized measuring tools are more expensive than the conventional calipers and reduces overall efficiency.

There is an urgent need to design a digital caliper that offers high-precision measurements for small-diameter holes, improving both accuracy and efficiency.

### SUMMARY

To solve the aforesaid problems, the first objective of the disclosure is to provide a digital caliper.

The digital caliper comprises a measurement assembly and an electronic module. The measurement assembly comprises a caliper frame and a caliper body. The caliper frame is slidable on the caliper body.

The electronic module comprises a displacement sensor and a function module. The displacement sensor comprises a fixed grating plate and a movable grating plate. The displacement sensor further comprises a sensor chip disposed on the movable grating plate. The sensor chip is used to detect electrical signals corresponding to the displacement of the movable grating plate to the fixed grating plate. The fixed grating plate is fixedly disposed on the caliper body. The movable grating plate is electrically connected to the function module. The movable grating plate is fixedly disposed on the caliper frame. As the caliper frame moves, the movable grating plate moves together with the caliper frame. The function module comprises a microcontroller, a measurement trigger mechanism, and a set button. The measurement trigger mechanism is configured to generate an on/off electrical signal when the caliper frame is moved. The digital caliper further comprises two inner jaws. Each of the two inner jaws comprises a measuring surface adapted to make contact with the object being measured. The measurement trigger mechanism comprises an inner jaw switch and an outer jaw switch. The inner jaw switch is electrically connected to the microcontroller. The outer jaw switch is electrically connected to the microcontroller.

A method of measuring an inner diameter of a hole using the digital caliper, and the method comprises:
applying a force to move the caliper frame for measurement; pressing the inner jaw button to active the inner jaw switch, or pressing the outer jaw button to active the outer jaw switch; and performing high-resolution sampling of, using the microcontroller, displacement values from the displacement sensor; wherein, the inner jaw switch or the outer jaw switch is activated and sends an “on” electrical signal to the microcontroller, triggering the microcontroller to begin the high-resolution sampling of the displacement values;
ensuring the two measuring surfaces are in full contact with the object being measured; removing the applied force; sending, using the inner jaw switch or the outer jaw switch, an “off” electrical signal to the microcontroller; wherein, when the force is removed, the two measuring surfaces recover from elastic deformation, and the recovery causes the caliper frame to move due to a restoring force of the elastic deformation;
continuously performing the high-resolution sampling of, using the microcontroller, the displacement values from the displacement sensor during a recovery process; comparing, using the microcontroller, nₜₕ sampled displacement value (An) with (n−1)ₜₕ sampled displacement value (A(n−1)); wherein, when a difference between the nₜₕ sampled displacement value (An) and the (n−1)ₜₕ sampled displacement value (A(n−1)) is less than a predefined threshold, the measurement is considered to have stabilized; and
outputting, using the microcontroller, the stabilized nₜₕ sampled displacement value (An) as a final measurement value.

In a class of this embodiment, performing high-resolution sampling further comprises:
identifying, using the microcontroller, whether the inner jaw switch or the outer jaw switch is activated; and
automatically correcting, using the microcontroller, a zero-point error when activating the inner jaw switch.

In a class of this embodiment, automatically correcting a zero-point error further comprises: measuring, using the two inner jaws, a standard groove with a known value to obtain a measured value, comparing the known value with the measured value to obtain the zero-point error; and subtracting the zero-point error from the displacement values.

In a class of this embodiment, when the two measuring surfaces are two knife-edge measuring surfaces, a displacement error occurs because a total thickness of the two knife-edge measuring surfaces and a gap between the two inner jaws; to achieve an accurate measurement using the two knife-edge measuring surfaces, the microcontroller employs the following formula to calculate an actual inner diameter of a hole:

$$D = 2 * \sqrt{{( C / 2 )}^{2} + {( A / 2 )}^{2}}$$

where, C is a total thickness of the two inner jaws and the gap between the two inner jaws, A is the displacement value from the displacement sensor, and D is the actual inner diameter of the hole. A displacement error is represented by a difference between the actual inner diameter D of the hole and the displacement value A.

In a class of this embodiment, when the digital caliper is assembled, the total thickness C is calculated as follows: measuring, using the digital caliper, a ring gauge with a known inner diameter D; obtaining the displacement value A from the displacement sensor, and calculating the total thickness C using the following formula:

$$C = 2 * \sqrt{{( D / 2 )}^{2} - {( A / 2 )}^{2}}$$

Specifically, during the operation of the digital caliper, the caliper frame is pushed or pulled to activate the measurement trigger mechanism. The measurement trigger mechanism is activated to generate the on/off electrical signal to the microcontroller. Upon receiving the “on” electrical signal, the microcontroller begins the high-resolution sampling, converting the displacement values into digital values with a resolution of 0.001 mm, improving the measurement resolution from 0.01 mm to 0.001 mm for enhanced precision. Upon receiving the “off” electrical signal, the microcontroller identifies when the caliper frame reaches a steady state. When the steady state is reached, the microcontroller records the displacement value from the steady state as the final measurement value. The identifying process incorporates a quasi-constant-force method, minimizing variability caused by operators applying different levels of the force.

Additionally, the microcontroller detects whether the inner jaw switch or the outer jaw switch is activated. For the measurement with the inner jaws, the microcontroller automatically corrects the zero-point error, reducing operator errors and improving ease of use. To identify the zero-point error, the standard groove with the known value is measured using the inner jaws of the digital caliper. The difference between the measured value from the inner jaws and the known value of the standard groove represents the zero-point error. The identified zero-point error is stored in the memory unit and used later to correct the displacement value.

Additionally, to eliminate the displacement error that occurs during the use of the two knife-edge measuring surfaces, the microcontroller employs the following formula to directly calculate the actual inner diameter of the hole:

$$D = 2 * \sqrt{{( C / 2 )}^{2} + {( A / 2 )}^{2}} ,$$

where, C is the total thickness of the two knife-edge measuring surfaces and the gap between the two inner jaws, A is the displacement value from the displacement sensor, and D is the actual inner diameter of the hole. A displacement error is represented by a difference between the actual inner diameter D of the hole and the displacement value A.

The total thickness C is calculated as follows: a ring gauge with a known inner diameter D is measured using a caliper; the displacement value A is obtained from the displacement sensor; and the total thickness C is calculated using the following:

$$C = 2 * \sqrt{{( D / 2 )}^{2} - {( A / 2 )}^{2}} .$$

The total thickness C is calculated and stored in the memory unit before the digital caliper leaves the factory. Alternatively, the total thickness C is recalculated during use through a program.

### BRIEF DESCRIPTION OF THE DRAWINGS

Implementations of the disclosure will now be described in detail with reference to the drawings, which are provided as illustrative examples so as to enable those skilled in the art to practice the present technology. Notably, the figures and examples below are not meant to limit the scope of the disclosure to a single implementation and the drawings may not be in scale.

FIG. 1 is a block diagram illustrating a working principle of a digital caliper according to one example of the disclosure;

FIG. 2 is a schematic diagram of measuring an inner diameter of a hole according to one example of the disclosure;

FIG. 3A is a schematic diagram illustrating a relationship between displacement and an applied force during measurements with an inner jaw according to one example of the disclosure; FIG. 3B is a schematic diagram illustrating a relationship between displacement and an applied force during measurements with an outer jaw according to one example of the disclosure;

FIG. 4 is a schematic diagram of a functional module according to one example of the disclosure;

FIG. 5 is a schematic diagram showing a positioning of a functional module in relation to other components according to one example of the disclosure;

FIG. 6 is a schematic diagram of a digital caliper according to one example of the disclosure; and

FIG. 7 is a flowchart illustrating operational steps of a digital caliper according to one example of the disclosure.

In the drawings, the following reference numbers are used: 1. Measurement assembly; 2. Electronic module; 11. Inner body jaw; 12. Outer body jaw; 21. Inner frame jaw; 22. Outer frame jaw; 23. Inner jaw button; 24. Outer jaw button; 25. Set button; 26. Microcontroller; 30. Inner jaw switch; and 40. Outer jaw switch.

### DETAILED DESCRIPTION

To further illustrate the disclosure, embodiments detailing a digital caliper and a method of measuring an inner diameter of a hole using the same are described below. It should be noted that the following embodiments are intended to describe and not to limit the disclosure.

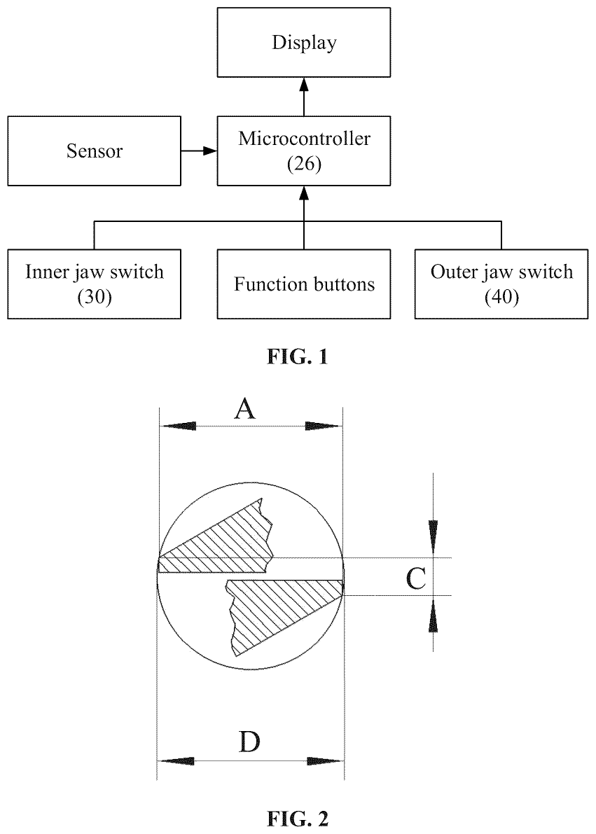

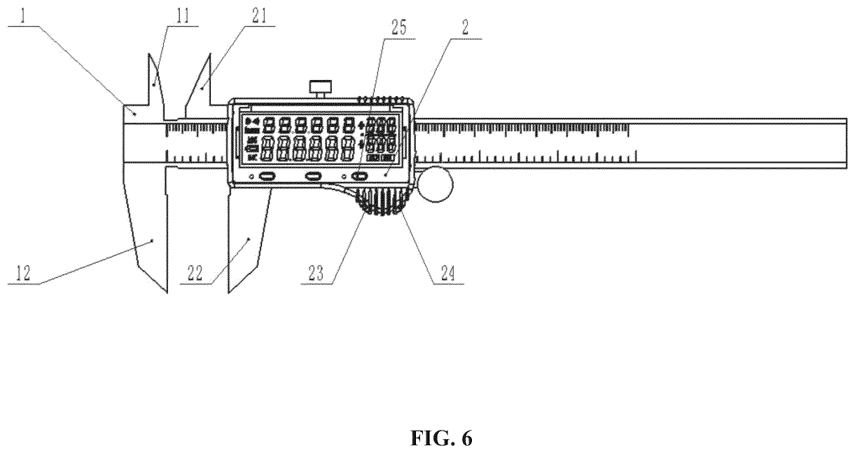

As shown in FIGS. 1-6, a digital caliper comprises a measurement assembly 1 and an electronic module 2. The measurement assembly 1 comprises a caliper frame and a caliper body. The caliper frame is slidable on the caliper body.

The electronic module 2 comprises a displacement sensor and a function module. The displacement sensor comprises a fixed grating plate and a movable grating plate. The displacement sensor further comprises a sensor chip disposed on the movable grating plate. The sensor chip is used to detect electrical signals corresponding to the displacement of the movable grating plate to the fixed grating plate. The fixed grating plate is fixedly disposed on the caliper body. The movable grating plate is electrically connected to the function module. The movable grating plate is fixedly disposed on the caliper frame. As the caliper frame moves, the movable grating plate moves together with the caliper frame. The function module comprises a microcontroller 26, a measurement trigger mechanism, and a set button 25. When the caliper frame is moved, the measurement trigger mechanism generates an on/off electrical signal to the microcontroller. The measurement trigger mechanism comprises an inner jaw switch 30 and an outer jaw switch 40. The inner jaw switch 30 is electrically connected to the microcontroller 26. The outer jaw switch 40 is electrically connected to the microcontroller 26.

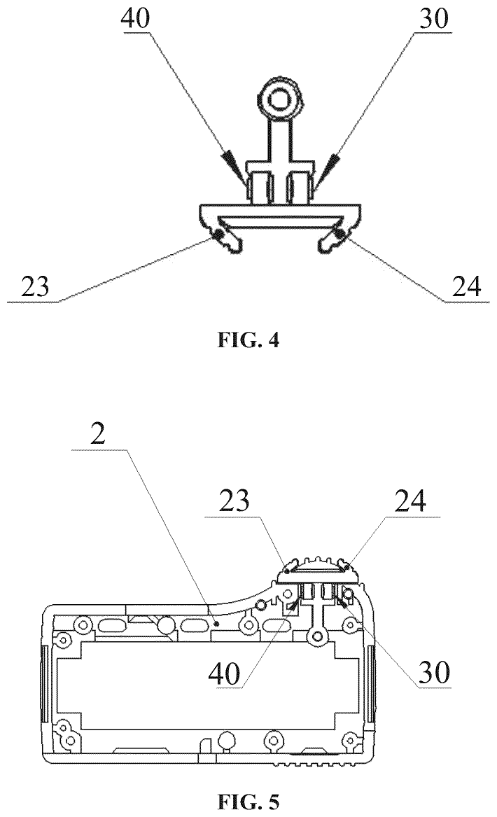

In certain embodiment, as shown in FIGS. 4, 5, and 6, a digital caliper comprises a measurement assembly 1 and an electronic module 2. The measurement assembly 1 comprises a caliper frame and a caliper body. The caliper body comprises an inner body jaw 11 and an outer body jaw 12. The caliper frame comprises an inner frame jaw 21 and an outer frame jaw 22. The inner body jaw 12 and the inner frame jaw 22 form two inner jaws. The outer body jaw 11 and the outer frame jaw 21 form two outer jaws. The caliper frame is slidable on the caliper body. The electronic module 2 comprises a displacement sensor and a function module. The displacement sensor is a high-resolution grating sensor. The displacement sensor comprises a fixed grating plate and a movable grating plate. The function module comprises a microcontroller 26, an inner jaw button 23, an outer jaw button 24, an inner jaw switch 30, an outer jaw switch 40, and a set button 25. The fixed grating plate is fixedly disposed on the caliper body. The movable grating plate is electrically connected to the function module. The movable grating plate is fixedly disposed on the caliper frame. As the caliper frame moves, the movable grating plate moves together with the caliper frame. During the movement, when the two inner jaws are in full contact with the object being measured, the inner jaw switch 30 is pressurized; similarly, when the two outer jaws are in full contact with the object of being measured, the outer jaw switch 40 is pressurized. The pressure triggers the inner jaw switch 30 or the outer jaw switch 40 to close or open, generating the on/off electrical signal. The on/off electrical signal is transmitted to the microcontroller. The microcontroller processes the on/off electrical signal to capture and calculate the measurement.

In certain embodiments, when the two measuring surfaces are two knife-edge measuring surfaces, a displacement error occurs because a total thickness of the two knife-edge measuring surfaces and a gap between the two inner jaws. As shown in FIG. 2, C is the total thickness of the two knife-edge measuring faces and the gap between the two inner jaws, A is the displacement value from the displacement sensor, and D is the actual inner diameter of a circular ring. To achieve an accurate measurement using the two knife-edge measuring surfaces, the displacement error is corrected by the microcontroller using the following formula:

$$D = 2 * \sqrt{{( C / 2 )}^{2} + {( A / 2 )}^{2}} ,$$

The formula incorporates trigonometric relationships between the displacement value A, the total thickness C, and the actual inner diameter D of the circular ring. The displacement error is represented by a difference between the actual inner diameter D of the circular ring and the displacement value A. Therefore, by applying the formula, a precise value for the inner diameter of the circular ring is obtained. When the digital caliper is assembled, the total thickness C is considered as a constant value. When the value of the total thickness C is known, the displacement value A is used to calculate the actual inner diameter D of the circular ring. The total thickness C is calculated as follows: a ring gauge with a known inner diameter D is measured using the digital caliper; the displacement value A is obtained from the displacement sensor; and the total thickness C is calculated using the following formula:

$$C = 2 * \sqrt{{( D / 2 )}^{2} - {( A / 2 )}^{2}}$$

The microcontroller comprises a memory unit. The total thickness C is calculated and stored in the memory unit before the digital caliper leaves the factory. Alternatively, the total thickness C is recalculated during use through a program. When the inner diameter measurement function is selected by the user (via the set button 25), the microcontroller automatically uses the stored or recalculated total thickness C to adjust the displacement value from the displacement sensor.

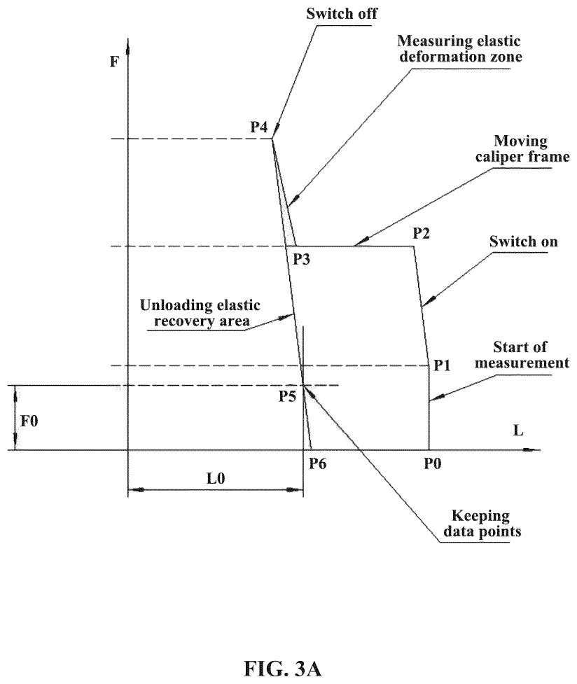

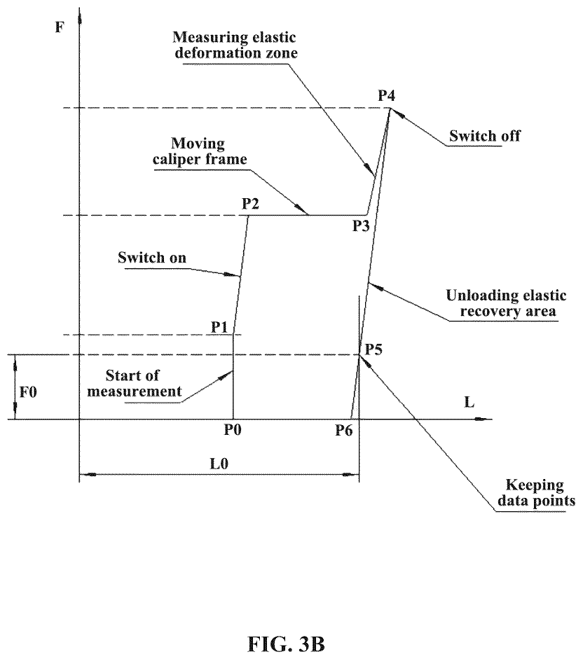

Conventional handheld calipers do not have a built-in mechanism to ensure that a force applied to the object being measured during the measurement remains consistent. Variations in the applied force can lead to distorted or inaccurate measurements. Both the inner jaws and the outer jaws exhibit a relationship between displacement and the applied force, as shown in FIGS. 3A-3B. A quasi-constant-force method is used to minimize the variations and performed as follows: the caliper frame is moved; during the movement, the inner jaw button 23 is pressed to activate the inner jaw switch 30, or the outer jaw button 24 is manually pressed to activate the outer jaw switch 40; the inner jaw switch 30 or the outer jaw switch 40 is activated and generates the “on” electrical signal to the microcontroller 26, triggering the microcontroller 26 to begin the high-resolution sampling of the displacement values; when the object is in full contact with the two measuring surfaces, the force is removed; at the same time, the inner jaw switch 30 or the outer jaw switch 40 sends the “off” electronic signal to indicate that the force has been removed; when the force is removed, the measuring surfaces rapidly recover from elastic deformation, and the caliper frame moves slightly due to the restoring force of the elastic deformation; the microcontroller 26 continuously performs high-resolution sampling of the displacement values from the displacement sensor during the recovery process and compares the sampled displacement values; when the difference between the nₜₕ sampled displacement value (An) and the (n−1)ₜₕ sampled displacement value (A(n−1)) is less than a predefined threshold N (preferably, 0.001 mm), the measurement is considered to have stabilized; when the sampled displacement values has stabilized, the microcontroller 26 outputs the stabilized nₜₕ sampled displacement value as the final measurement value.

When the inner jaws are used for measurement, a zero-point error may occur due to discrepancies in the manufacturing and installation of the measuring surfaces of the inner jaws and the outer jaws. The zero-point error affects the accuracy of the measurements, specifically when measuring the inner diameter of the object, and is corrected by subtraction. To identify the zero-point error, a standard groove with a known value is measured using the inner jaws. The difference between the measured value from the inner jaws and the known value of the standard groove represents the zero-point error. The identified zero-point error is stored in the memory unit and is used later to correct the displacement value. The displacement value is captured from the displacement sensor using the quasi-constant-force method to minimize the errors caused by human variability during the measurement. During the operation of the digital caliper, the microcontroller identifies whether the inner jaw switch or the outer jaw switch is activated. For the measurement with the inner jaws, the microcontroller automatically subtracts the zero-point error from the displacement value, ensuring more accurate measurements.

When the outer jaws are used for measurement, the digital caliper employs the quasi-constant-force method to reduce the variations in the applied force during the measurement. The digital caliper integrates a high-resolution capacitive grid sensor, as disclosed in U.S. Pat. No. 11,940,302. The high-resolution capacitive grid sensor allows for high-resolution sampling of the displacement values, converting the displacement values into digital values with a resolution of 0.001 mm. The improvement enhances the precision of the measurement, particularly for measuring small inner diameters, where high accuracy is required.

The digital caliper combines the high-resolution capacitive grid sensor with the microcontroller to allow for high-resolution sampling of the displacement values, particularly for small holes or inner diameters. The digital caliper also employs the quasi-constant-force method. To further enhance precision, the digital caliper corrects for the zero-point error during measurements with the inner jaws, and also eliminates the displacement error. As a result, the digital caliper achieves micron-level precision for measurements with both the inner jaws and the outer jaws.

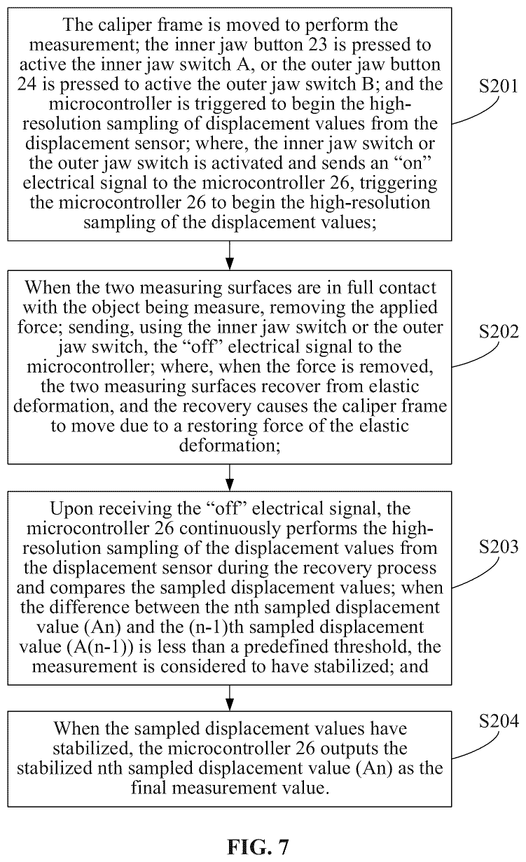

FIG. 7 is a flowchart illustrating a method of measuring an inner diameter of a hole using the digital caliper. The method comprises:
S201: the caliper frame is moved to perform the measurement; the inner jaw button 23 is pressed to active the inner jaw switch 30, or the outer jaw button 24 is pressed to active the outer jaw switch 40; and the microcontroller is triggered to begin the high-resolution sampling of displacement values from the displacement sensor; where, the inner jaw switch or the outer jaw switch is activated and sends an “on” electrical signal to the microcontroller 26, triggering the microcontroller 26 to begin the high-resolution sampling of the displacement values;
S202: when the two measuring surfaces are in full contact with the object being measure, removing the applied force; sending, using the inner jaw switch or the outer jaw switch, the “off” electrical signal to the microcontroller; where, when the force is removed, the two measuring surfaces recover from elastic deformation, and the recovery causes the caliper frame to move due to a restoring force of the elastic deformation;
S203: upon receiving the “off” electrical signal, the microcontroller 26 continuously performs the high-resolution sampling of the displacement values from the displacement sensor during the recovery process and compares the sampled displacement values; when the difference between the nₜₕ sampled displacement value (An) and the (n−1)ₜₕ sampled displacement value (A(n−1)) is less than a predefined threshold, the measurement is considered to have stabilized; and
S204: when the sampled displacement values have stabilized, the microcontroller 26 outputs the stabilized nu sampled displacement value (An) as the final measurement value.

Specifically, during the operation of the digital caliper, the caliper frame is pushed or pulled to activate the measurement trigger mechanism. The measurement trigger mechanism is activated to generate the on/off electrical signal to the microcontroller. Upon receiving the “on” electrical signal, the microcontroller begins the high-resolution sampling, converting the displacement values into digital values with a resolution of 0.001 mm, improving the measurement resolution from 0.01 mm to 0.001 mm for enhanced precision. Upon receiving the “off” electrical signal, the microcontroller identifies when the caliper frame reaches the steady state. When the steady state is reached, the microcontroller records the displacement value from the steady state as the final measurement value. The identifying process incorporates the quasi-constant-force method, minimizing variability caused by operators applying different levels of the force. The quasi-constant-force method is performed as follows: the caliper frame is moved; during the movement, the inner jaw button 23 is pressed to activate the inner jaw switch 30, or the outer jaw button 24 is pressed to activate the outer jaw switch 40; the inner jaw switch 30 or the outer jaw switch 40 is activated and generates the “on” electrical signal to the microcontroller 26, triggering the microcontroller 26 to begin the high-resolution sampling of the displacement values; when the object is in full contact with the two measuring surfaces, the force is removed; at the same time, the inner jaw switch 30 or the outer jaw switch 40 sends the “off” electronic signal to indicate that the force has been removed; when the force is removed, the measuring surfaces rapidly recover from elastic deformation, and the caliper frame moves slightly due to the restoring force of the elastic deformation; upon receiving the “off” electronic signal, the microcontroller 26 continuously performs high-resolution sampling of the displacement values from the displacement sensor during the recovery process and compares the sampled displacement values; when the difference between the nₜₕ sampled displacement value (An) and the (n−1)ₜₕ sampled displacement value (A(n−1)) is less than a predefined threshold N (preferably, 0.001 mm), the measurement is considered to have stabilized; when the sampled displacement values has stabilized, the microcontroller 26 outputs the stabilized nₜₕ sampled displacement value as the final measurement value.

Additionally, the microcontroller detects whether the inner jaw switch or the outer jaw switch is activated. For the measurement with the inner jaws, the microcontroller automatically corrects the zero-point error, reducing operator errors and improving ease of use. To identify the zero-point error, the standard groove with the known value is measured using the inner jaws of the digital caliper. The difference between the measured value from the inner jaws and the known value of the standard groove represents the zero-point error. The identified zero-point error is stored in the memory unit and used later to correct the displacement value.

Additionally, to eliminate the displacement error that occurs during the use of the two knife-edge measuring surfaces, the microcontroller employs the following formula to directly calculate the actual inner diameter of the hole:

$$D = 2 * \sqrt{{( C / 2 )}^{2} + {( A / 2 )}^{2}} ,$$

where, C is the total thickness of the two knife-edge measuring surfaces and the gap between the two inner jaws, A is the displacement value from the displacement sensor, and D is the actual inner diameter of the hole. A displacement error is represented by a difference between the actual inner diameter D of the hole and the displacement value A.

The total thickness C is calculated as follows: a ring gauge with a known inner diameter D is measured using a caliper; the displacement value A is obtained from the displacement sensor; and the total thickness C is calculated using the following:

$$C = 2 * \sqrt{{( D / 2 )}^{2} - {( A / 2 )}^{2}} .$$

The total thickness C is calculated and stored in the memory unit before the digital caliper leaves the factory. Alternatively, the total thickness C is recalculated during use through a program.

It will be obvious to those skilled in the art that changes and modifications may be made, and therefore, the aim in the appended claims is to cover all such changes and modifications.

What is claimed is:

1. A digital caliper, comprising:
a measurement assembly; and
an electronic module;
wherein,
the measurement assembly comprises a caliper frame and a caliper body; the caliper frame is slidable on the caliper body;
the electronic module comprises a displacement sensor and a function module; the displacement sensor comprises a fixed grating plate and a movable grating plate; the displacement sensor further comprises a sensor chip disposed on the movable grating plate; the fixed grating plate is fixedly disposed on the caliper body; the movable grating plate is electrically connected to the function module; the movable grating plate is fixedly disposed on the caliper frame, and is movable together with the caliper frame; the function module comprises a microcontroller, a measurement trigger mechanism, and a set button; the measurement trigger mechanism is configured to generate an on/off electrical signal when the caliper frame is moved; the digital caliper further comprises two inner jaws; each of the two inner jaws comprises a measuring surface adapted to make contact with an object being measured; the measurement trigger mechanism comprises an inner jaw switch and an outer jaw switch; the inner jaw switch is electrically connected to the microcontroller; and the outer jaw switch is electrically connected to the microcontroller.

2. A method of measuring an inner diameter of a hole using the digital caliper of claim 1, the method comprising:
applying a force to move the caliper frame for measurement; pressing an inner jaw button to active the inner jaw switch, or pressing an outer jaw button to active the outer jaw switch; and performing high-resolution sampling of, using the microcontroller, displacement values from the displacement sensor; wherein, the inner jaw switch or the outer jaw switch is activated and sends an “on” electrical signal to the microcontroller, triggering the microcontroller to begin the high-resolution sampling of the displacement values;
ensuring the two measuring surfaces are in full contact with the object being measured; removing the applied force; sending, using the inner jaw switch or the outer jaw switch, an “off” electrical signal to the microcontroller; wherein, when the force is removed, the two measuring surfaces recover from elastic deformation, and the recovery causes the caliper frame to move due to a restoring force of the elastic deformation;
continuously performing the high-resolution sampling of, using the microcontroller, the displacement values from the displacement sensor during a recovery process; comparing, using the microcontroller, nₜₕ sampled displacement value (An) with (n−1)ₜₕ sampled displacement value (A(n−1)); wherein, when a difference between the nₜₕ sampled displacement value (An) and the (n−1)ₜₕ sampled displacement value (A(n−1)) is less than a predefined threshold, the measurement is considered to have stabilized; and
outputting, using the microcontroller, the stabilized nₜₕ sampled displacement value (An) as a final measurement value.

3. The method of claim 2, wherein performing high-resolution sampling further comprises:
identifying, using the microcontroller, whether the inner jaw switch or the outer jaw switch is activated; and
automatically correcting, using the microcontroller, a zero-point error when activating the inner jaw switch;
wherein,
automatically correcting a zero-point error further comprises:
measuring, using the two inner jaws, a standard groove with a known value to obtain a measured value, comparing the known value with the measured value to obtain the zero-point error; and subtracting the zero-point error from the displacement values.

4. The method of claim 2, wherein when the two measuring surfaces are two knife-edge measuring surfaces, the microcontroller employs the following formula to calculate an actual inner diameter of the hole:
$$D = 2 * \sqrt{{( C / 2 )}^{2} + {( A / 2 )}^{2}}$$
where, C is a total thickness of the two knife-edge measuring surfaces and a gap between the two inner jaws, A is the displacement value from the displacement sensor, and D is the actual inner diameter of the hole.

5. The method of claim 4, wherein when the digital caliper is assembled, the total thickness C is calculated as follows: measuring, using the digital caliper, a ring gauge with a known inner diameter D; obtaining the displacement value A from the displacement sensor, and calculating the total thickness C using the following formula:
$$C = 2 * \sqrt{{( D / 2 )}^{2} - {( A / 2 )}^{2}} .$$
